(19) United States
(12) Patent Application Publication
(10) Pub. No.: US 2011/0032482 A1
(43) Pub. Date: Feb. 10, 2011

(54) 3D AUTOSTEREOSCOPIC DISPLAY WITH TRUE DEPTH PERCEPTION

(75) Inventor: Ilya Agurok, Santa Clarita, CA (US)

Correspondence Address: DRINKER BIDDLE & REATH;ATTN: INTELLECTUAL PROPERTY GROUP, ONE LOGAN SQUARE, SUITE 2000, PHILADELPHIA, PA, 19103-6996, US

(73) Assignee: Light Prescriptions Innovators, LLC, Altadena, CA (US)

(21) Appl. No.: 12/850,753

(22) Filed: Aug. 5, 2010

Related U.S. Application Data
(60) Provisional application No. 61/273,743, filed on Aug. 7, 2009.

(51) Int. Cl. G02B 27/22

(52) U.S. Cl. 353/7

(57) ABSTRACT

An autostereoscopic display provides true natural perception of 3D scenes by projecting depth-slice images of objects located at different distances, so during each video frame the scene is segmented into five or more different depths and then each displayed in succession with both the stereo disparity and apparent image distance proper for each depth.

### CROSS REFERENCE TO RELATED APPLICATIONS

This application claims benefit of U.S. Provisional Patent Application No. 61/273,743, filed Aug. 7, 2009, which is incorporated herein by reference in its entirety.

### BACKGROUND OF THE INVENTION

The perception of 3D scenes by human vision is largely based on two mutually interacting visual adaptation processes—stereoscopy and the eye's focal accommodation to object distance. Because the typical eye separation is about 60 mm, fixation upon objects at different distances gives different angles of convergence between the axes of the eyes, known as the “stereovision” effect or “stereoshift.” Though usually unconscious, this convergence angle is registered by the brain and contributes to the perception of object distance. To provide high resolution imaging of objects at different distances, the eye adjusts the shape, and thus the optical power, of the lens so it sharply focuses objects at a selected distance, a phenomenon known as “accommodation.” These two processes cooperate and engender accurate depth perception. For natural viewing of an object, the convergence and accommodation of the viewer's eyes should both be correct for the distance to the object.

There are several types of stereo displays that use stereo effects to simulate the perception of the 3D vision. In U.S. Pat. No. 4,734,756, a stereovision system generates on a screen stereoshifted images of the scene in two colors. The observer is wearing eye glasses with lenses of two different colors, and can see only one of the two images with each eye. The mixture of two images in the brain creates monochrome stereovision perception. This method usually is referenced as the anaglyph technique. U.S. Pat. Nos. 5,537,144; 5,594,843; 5,745,164 disclose glasses with perpendicularly aligned polarizing lenses for separate delivery of stereoshifted images to the left and right eyes. In U.S. Pat. No. 5,821,989, the stereoshifted images for left and right eye are repeatedly generated in a time sequence and liquid crystal shutter glasses are used to expose each eye in time with the respective image. U.S. Pat. No. 5,886,675 proposed an autostereoscopic display that does not need the use of special glasses. Two projectors generate images upon a holographic screen that conjugates the exit pupil of one projector with the pupil of the observer's left eye and the exit pupil of the second projector with the pupil of the right eye.

However, in all these techniques, the actual image viewed by the observer is at a fixed single distance from the observer, so that “objects” at supposed different distances are in fact all in focus at the same accommodation of the lens of the eye. This creates unnatural perception of a 3D scene that contains a number of objects at different supposed distances, for example, scenes with a close object in front of a landscape background. A true 3D display has not only to provide for the imaging of objects at different supposed distances stereoshift simulation but also to present the visible (usually virtual) image of the object at a distance from the observer's eye that adequately simulates the supposed distance to the object, so that the observer's eye can use both vision distance adaptation processes—stereovision and distance accommodation.

U.S. Pat. No. 5,956,180 proposed to use several screens at different distances from the observer with a beam combiner for 3D scene simulation. The problem is that the number of distance “slices” is in practice restricted to 2, and such an arrangement has problems with simulation of combinations of close and remote scenes together. In other words, the dynamic range of distance simulation is very limited. Another approach for comprehensive 3D scene simulation is found in displays that use variable computer generated holograms, as proposed in US patent application 2006/0187297. The holographic approach may provide comprehensive 3D scene perception but will experience problems with dynamic scenes due to its extremely high computation burden, as well as the limitations associated with RGB projection and image resolution.

The present invention provides autostereoscopic dynamic scene projection with improved depth perception over the prior art.

### SUMMARY OF THE INVENTION

An embodiment of the presently proposed autostereoscopic display will have two scene projectors. The exit pupil of one projector is conjugated with the pupil of the left eye of the observer, while the exit pupil of the second projector is conjugated with the pupil of the right eye of the observer. The projector pupil diameter exceeds the eye pupil diameter to provide a reasonably sized “eye box,” the region within which the eye must be positioned to see the projected image fully. This provides for comfortable vision, by allowing some movement of the eye without losing the view of the image. The two projectors deliver to the observer's eyes 2D “depth-slice” images of the 3D scene with a stereoshift.

In one embodiment, variable-curvature membrane micromachined mirrors are incorporated into the projection scheme to provide appropriate real time image distance simulation by generating an image of each “slice” of the 3D scene at the correct distance from the observer for the objects in that slice. An alternative embodiment uses multiple layered liquid crystal lenses that perform a similar function. The pairs of slice images are generated so as to have the corresponding stereoshift for the slice distance. The observer can focus his or her eyes on a chosen scene “slice,” and the focusing accommodation can then be consistent with the convergence induced by the stereoshift. Consistent distance perception can thus be achieved.

With current technology, at least five depth “slices” can be projected during each image frame. The minimum frame refresh time is typically around thirty milliseconds, or 30 cps, to avoid a visible flicker. However, more than five depth slices can be provided as long as there is sufficient brightness for each “image” slice to provide sufficient luminous flux for each slice, and as long as the image generating and focusing elements of the system can change from slice to slice sufficiently quickly. There is no real limit to the number of slices that can be handled by a typical observer. This novel approach has many applications including: more realistic 3D games, military and civilian simulations, opthalmological testing, to name a few.

In an embodiment, an achromatic negative doublet is positioned in the path of light to and from said deformable mirror. The doublet is selected to shifting the required range of powers of the deformable mirror for the desired apparent slice distances, so that in normal operation the mirror is always concave, optionally including a flat position at one end of its range.

Aspects of the invention also provide methods of displaying a 3D image that comprises supplying slice images corresponding to parts of a scene at different distances from a viewer, and displaying each slice image in turn using different settings of a variable power optical element so as to create an apparent image of each slice image at an appropriate apparent distance from an observer position.

In an embodiment, the method comprises displaying different images to each eye of an observer, and stereoshifting the slice images displayed to different eyes to give parallax and eye convergence consistent with the apparent distances of the different slices.

### BRIEF DESCRIPTION OF THE DRAWINGS

The above and other aspects, features and advantages of the present invention will be apparent from the following more particular description thereof, presented in conjunction with the following drawings wherein:

FIG. 1 is a schematic side view of an optical layout of a first embodiment of a projector.

FIG. 2 is a perspective view of a solid model of the projector shown in FIG. 1.

FIG. 3 is an MTF diagram for the projector of FIG. 1 when displaying objects at infinity.

FIG. 4 is a spot diagram for the same conditions as FIG. 3.

FIG. 5 is an MTF diagram for the projector of FIG. 1 when displaying an object at 1.1 meters from the eye.

FIG. 6 is a spot diagram for the same conditions as FIG. 5.

FIG. 7 is a schematic side view of an optical layout of a second embodiment of a projector.

FIG. 8 is an MTF diagram for the projector of FIG. 7 when displaying objects at infinity and when the observer's eye is at the center of the eyebox.

FIG. 9 is an MTF diagram for the projector of FIG. 7 when displaying objects at infinity and when the observer's eye is at the edge of eyebox.

FIG. 10 shows an entire binocular system.

FIG. 11 is a flow chart for the electronic processing within an embodiment of a binocular system.

### DETAILED DESCRIPTION OF THE PREFERRED EMBODIMENTS

A better understanding of various features and advantages of the present invention may be obtained by reference to the following detailed description and accompanying drawings, which set forth illustrative embodiments in which principles of the invention are utilized.

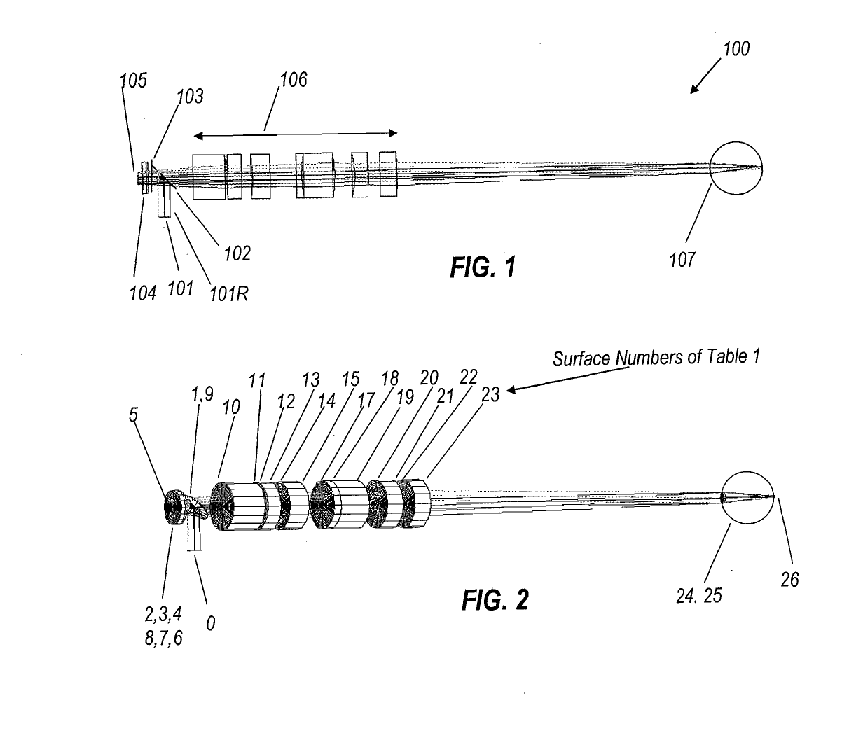

Referring to the drawings, and initially to FIGS. 1 to 6, an embodiment of the autostereoscopic display for a human observer with two eyes has two scene projectors. The optical layout of one projector is shown in FIG. 1 which shows a side-view of projector 100, comprising liquid-crystal (LC) display 101, polarization beamsplitter 102, quarter-wave plate 103, achromatic doublet lens 104, deformable membrane mirror 105, and reverse telephoto lens train 106. The output from projector 100 is viewed by eye 107. FIG. 2 shows the same projector 100 in perspective view, with the individual optical surfaces numbered in the order in which the light encounters them. Utilizing a polarization beamsplitter and quarter-wave plate presumes the linear polarization typical of collimated LC output, and they mitigate the usual 4:1 flux reduction of an ordinary 50-50 beamsplitter.

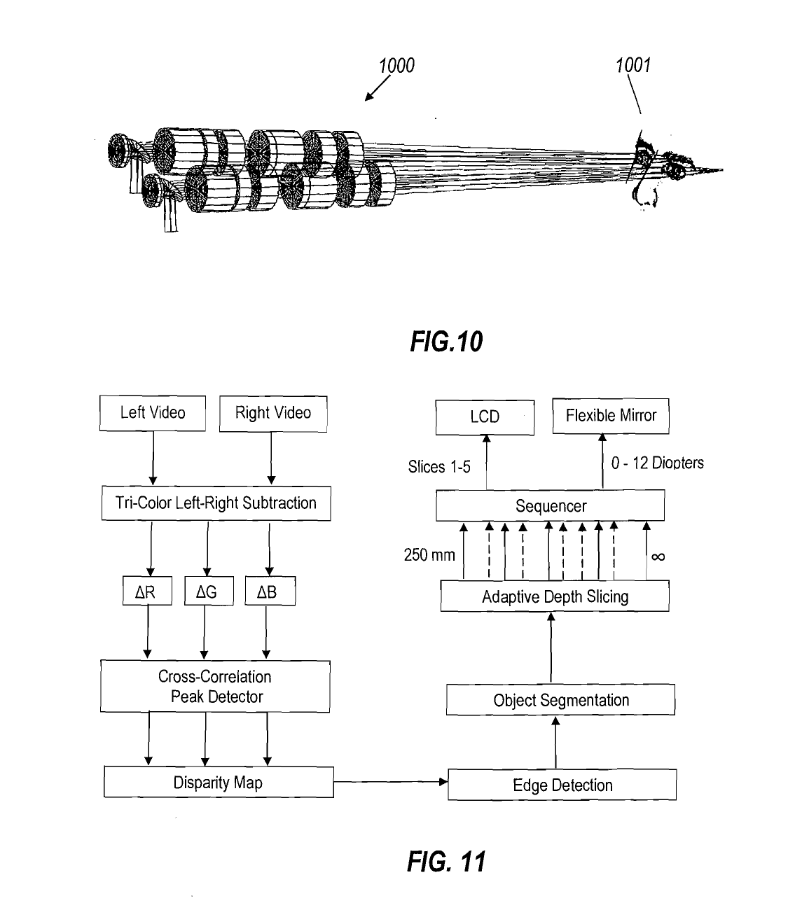

As shown by way of example in FIG. 10, the display may comprise two projectors 100 side by side. The projectors may be structurally identical, or mirror images of each other, and in the interests of conciseness only one projector 100 is shown and described. In use, the exit pupil of one projector is conjugated with the pupil of the left eye of an observer while the exit pupil of the second projector is conjugated with the pupil of the right eye of the observer. The projector pupil's diameter exceeds the eye pupil diameter of an observer, who in this embodiment is a representative adult human. The observer sees 2D “slices” of an image of a 3D scene. The two projectors present the slices to the observer's eyes with a stereoshift and at variable apparent distance from the observer.

Table 1 lists the optical-prescription surface list for the preferred embodiment shown in FIG. 1 and FIG. 2 using the labels from FIG. 2. The eye pupil as an aperture stop and the eye lens as a lens are separately itemized for clarity, although they are substantially at the same position.

TABLE 1

| | | | Distance to next | Glass to next |
|---|---|---|---|---|
| Surface | | Radius | surface | surface |
| 0 | (LC display) Object | Infinity (flat) | 12.5 | Air |
| 1 | (Beamsplitter) | Infinity | −5 | Mirror-air |
| 2 | | 377 | −0.5 | F2 |
| 3 | | −3331.64 | −1 | BK7 |
| 4 | | −34.15 | −1.7 | Air |
| 5 | | Five values | 1.7 | Mirror-air |
| 6 | | −34.15 | 1 | BK7 |
| 7 | | −3331.64 | 0.5 | F2 |
| 8 | | 377 | 5 | Air |
| 9 | (Beamsplitter) | Infinity | 9.29 | Air |
| 10 | | 958.87 | 10.51 | LAK14 |
| 11 | | −61.88 | 0.15 | Air |
| 12 | | 51.83 | 4.85 | LAK18 |
| 13 | | −186.02 | 3.35 | Air |
| 14 | | −53.35 | 5.45 | SF11 |
| 15 | | 333.09 | 5.81 | Air |
| 16 | | Infinity | 2.64 | Air |
| 17 | | −1226.04 | 1.602 | SF10 |
| 18 | | 35.55 | 10.41 | LASF43 |
| 19 | | −49.53 | 6.5 | Air |
| 20 | | −26.56 | 4.306 | K3 |
| 21 | | −641.14 | 3.905 | Air |
| 22 | | −2118.13 | 5.45 | LASF45 |
| 23 | | −72.12 | 100 | Air |
| 24 | Aperture Stop (Eye) | Infinity | 0 | Air |
| 25 | (Eye lens) | Paraxial F = 17 | 17 | |
| 26 | (Foveal Image) | 0 | | |

The image source (Surface 0 in Table 1) of the projector shown in FIG. 1 (“object” in the example in Table 1) is a compact LC display 101. The display 101 has a frame rate of 150 Hz or five times that of a typical LC display, and five times the frame rate of the projector as a whole. Within the time ( 1/30 second) allotted to each video frame, the LC display 101 produces five “slice frames,” each of which images one depth-slice of the input imagery, with the remainder of the frame being black. This is the source of a five-to-one brightness reduction (relative to a similar system projecting a 2D image) inherent to the design approach disclosed herein.

The beamsplitter 102 (Surface 1 in Table 1) directs the LCD output to the assembly of negative achromatic doublet 104 (bounded by surfaces 2, 3, and 4) and a Micromachined Membrane Deformable Mirror (MMDM) 105 (surface 5) made by Flexible Optics Corp or equivalent component from another manufacturer. This mirror can produce different curvatures at very rapid rates, 1000 Hz, which exceeds the projector requirements. Each curvature corresponds to a particular depth slice. The mirror 105 is synchronized with the LC display 101, so that each slice frame from the LCD display is reflected off the MMD mirror 105 at the correct mirror curvature to produce the appropriate image position for the slice.

After reflection by the membrane mirror 105, each depth slice passes back through the achromatic doublet 104 (Surfaces 6, 7, and 8 are Surfaces 4, 3, and 2 in reverse) and the beamsplitter (inactive surface 9) and is projected to the eye by a reverse telephoto lens (surfaces 10 through 23). Optically inactive surface 16 of Table 1 is an aperture stop of the reverse telephoto lens 106, and is separately enumerated for convenience. The position of the exit pupil of the projection lens 106 is conjugated with the eye pupil of the observer. The diameter of the projector exit pupil exceeds the pupil diameter of eye 107, in order to accommodate small shifts in the observer's head position, and also so that the distance between the two projectors does not need to be adjusted too critically for each observer. The reverse telephoto lens 106 is calculated to have sufficient back focus release for mounting the membrane mirror 105 and the LC display 101, and sufficient long distance exit pupil release for conjugation with an observer's eye pupil 100 mm from the last optical surface of the lens 106.

In the projector of FIG. 1, the membrane mirror 105 (surface 5 of Table 1) has a 6 mm clear aperture and can change its radius of curvature from infinity (flat) to 150 mm concave. The achromatic doublet 104 shifts the dynamic range so that the desired range of image positions can be achieved with the mirror never needing to be convex. The curved membrane mirror 105, in combination with the reverse telephoto lens 106, creates a virtual image of image-bearing output light of the LCD source 101. This virtual image (not shown) will be at a distance from the exit pupil 107 which is controlled by varying the curvature of the membrane mirror 105. Five radius of curvature values are each held for a fifth of a video frame, providing the proper depth positioning of virtual images.

The optical system 100 was designed for four configurations, listed in Table 2 below. Dimensions are in millimeters. In configurations 1, 2, and 3 the radius of curvature of the mirror 105 is 150 mm (i.e., curvature=0.006666 in Table 1) and the eye position laterally (in the Y direction) is on center or off center one millimeter. At this value of mirror radius of curvature the lens assembly 106 projects the image of LCD source 101 with a flat wavefront (i.e. from infinity, at depth-slice #1). The design assumes that a typical human eye focal length when it is focused at infinity is 17 mm.

TABLE 2

| Surface: | Parameter. | Config 1 | Config 2 | Config 3 | Config 4 |
|---|---|---|---|---|---|
| 5 | Curvature | 6.666E−3 | 6.666E−3 | 6.666E−3 | 0 |
| 24 | Y-axis | 1 | 0 | −1 | 0 |
| | decentering | | | | |
| 25 | Focal length | 17 | 17 | 17 | 16.75 |

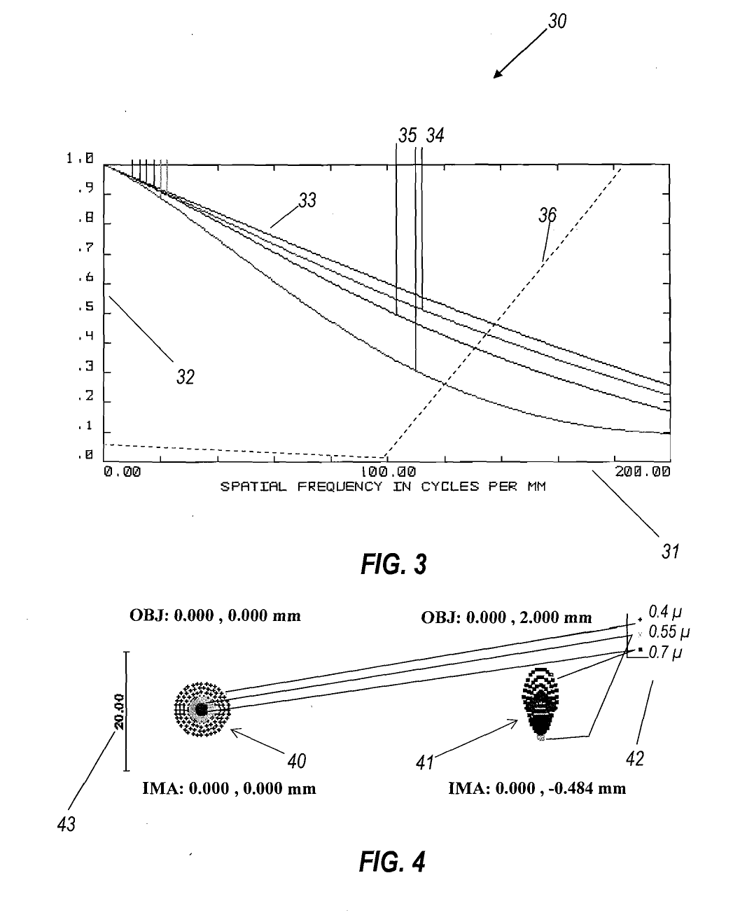

The system 100 of FIG. 1 was optimized for three eye positions: centered (Configuration 2), and laterally shifted ±1 mm (i.e., Configurations 1 and 3). FIG. 3 shows a Modulation Transfer Function (MTF) diagram 30 for the image quality of configuration 2, with the observer's eye on axis and focused at infinity. Any image pattern can be decomposed into an orthogonal set of spatial sine-waves, and any optical system can be fully characterized by its MTF, where modulation is a parameter that varies from 0 (a blank field) to 1 (a spatial sine wave with totally dark troughs). The MTF of any optical system is the output-image modulation generated by an input image with 100% modulation. The MTF is a function of the spatial frequency of the sine wave, and always declines monotonically from unity, for a blank field, to zero, for the system's highest spatial frequency.

The normal human retina can register 200 line pairs per mm, or 2.5 microns resolution, about the size of the cone cells in the retina. Only 100% modulation, however, is visible at this highest of all retinal spatial frequencies and no incoherent optical system can deliver that 100% modulation.

In FIG. 3, MTF diagram 30 comprises horizontal axis 31 for spatial frequency in cycles (or line pairs) per millimeter and vertical axis 32 for MTF ranging from 0 to 1. Topmost MTF curve 33 describes a theoretically perfect lens, known as diffraction limited, of the same diameter as those of FIG. 1. Curve 34 is MTF for the center of the instantaneous field of FIG. 1, while curves 35 are for the edge of the instantaneous viewed field, corresponding to a source point at 2.5 mm from the center of the object (surface 0). Both tangential (T) and sagittal (S) curves are shown, although for curves 33 and 34 the S and T curves are of course identical. Dotted lines 36 are a schematic sketch of the fovea's modulation threshold of visibility, above which all grating modulations are visible (G. Smith, D. Atchison “The eye and visual optical Instruments” Cambridge, 1997). At intermediate spatial frequencies, the eye can register quite low modulation levels, as indicated by the curve of 36. The point at which line 36 crosses MTF curves 34 or 35 indicates the actual system performance at the retina.

FIG. 4 shows retinal spot clusters 40 and 41 for the eye on-axis and respectively for the center of the instantaneous viewed field and the edge of the field, which is at 0.5 mm height at the retina. Legend box 42 indicates symbols used to distinguish spots for the three wavelengths of 0.4 (blue), 0.55 (green), and 0.7 microns (far red). The scale bar 43 of 20 μm retinal distance shows the excellent chromatic correction, by which the sizes of spot clusters 40 and 41 for different colors are nearly the same, and the spots for different colors in the edge cluster 41 nearly coincide.

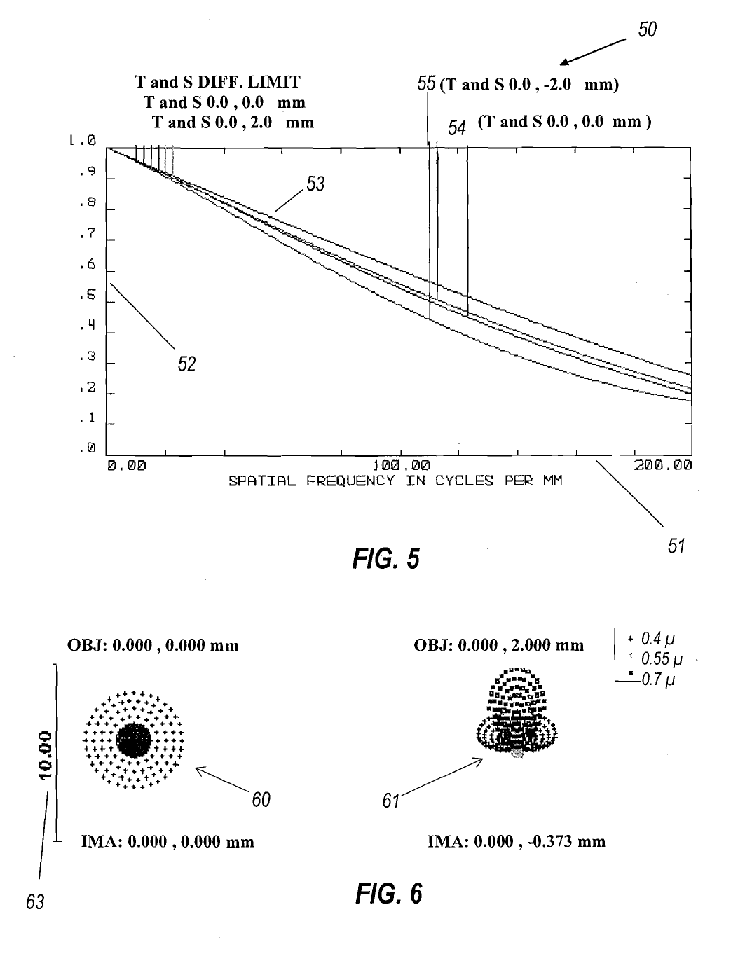

FIG. 5 and FIG. 6 describe the performance of Configuration 4, when the flexible mirror is flat, and the eye is fully accommodated. In fact, distance scale 63 of FIG. 6 is only 10 microns, half that of FIG. 4, indicating even better performance. The focal length of the accommodated eye is 16.75 mm. This means that the image distance within the eye for collimated incident light is 17 mm minus 16.75 mm, or 0.25 mm. From Newton's equation, the distance to an object correctly focused on the retina is then (16.75)²/0.25=1100 mm. An image will then be correctly focused on the retina if the image is projected from an apparent object distance of 1.1 meters (about 43 inches).

The optical prescription of a second embodiment of a suitable projector with extended field of view and larger eye box is shown in Table 3.

TABLE 3

| | | | Distance to | Glass to next | Aperture |
|---|---|---|---|---|---|
| Surface | | Radius | next surface | surface | (mm) |
| | Object | Infinity | 10.41 | Air | 7.4 |
| 1 | | Infinity | −6 | Mirror-air | |
| 2 | | −629.07 | −0.5 | F2 | |
| 3 | | 25.26 | −1 | BK7 | |
| 4 | | −37.57 | −2.33 | Air | |
| 5 | | Five values | 2.33 | Mirror-air | 10 |
| 6 | | −37.57 | 1 | BK7 | |
| 7 | | 25.26 | 0.5 | F2 | |
| 8 | | −629.07 | 6 | Air | |
| 9 | | Infinity | 9.29 | Air | |
| 10 | | −552.08 | 10.51 | LAK9 | |
| 11 | | −50.13 | 0.15 | Air | |
| 12 | | 209.73 | 4.85 | LAK18 | |
| 13 | | −132.76 | 3.35 | Air | |
| 14 | | −46.31 | 5.45 | SF11 | |
| 15 | | 205.25 | 5.81 | Air | |
| 16 | | Infinity | 2.64 | Air | |
| 17 | | −4735 | 1.602 | SF10 | |
| 18 | | −23.45 | 10.41 | LASF43 | |
| 19 | | −51.77 | 6.5 | Air | |
| 20 | | −32.69 | 4.306 | BK7 | |
| 21 | | 493 | 3.905 | Air | |
| 22 | | −274.84 | 5.45 | LASF41 | |
| 23 | | −53.82 | 100 | Air | |
| 24 | Aperture | Infinity | 0 | Air | 2 |
| | Stop | | | | |
| | (Eye) | | | | |
| 25 | Eye lens | Paraxial F = 17 | 17 | | |
| 26 | Image Plane | 0 | | | 1.7 |
| | (Retina) | | | | |

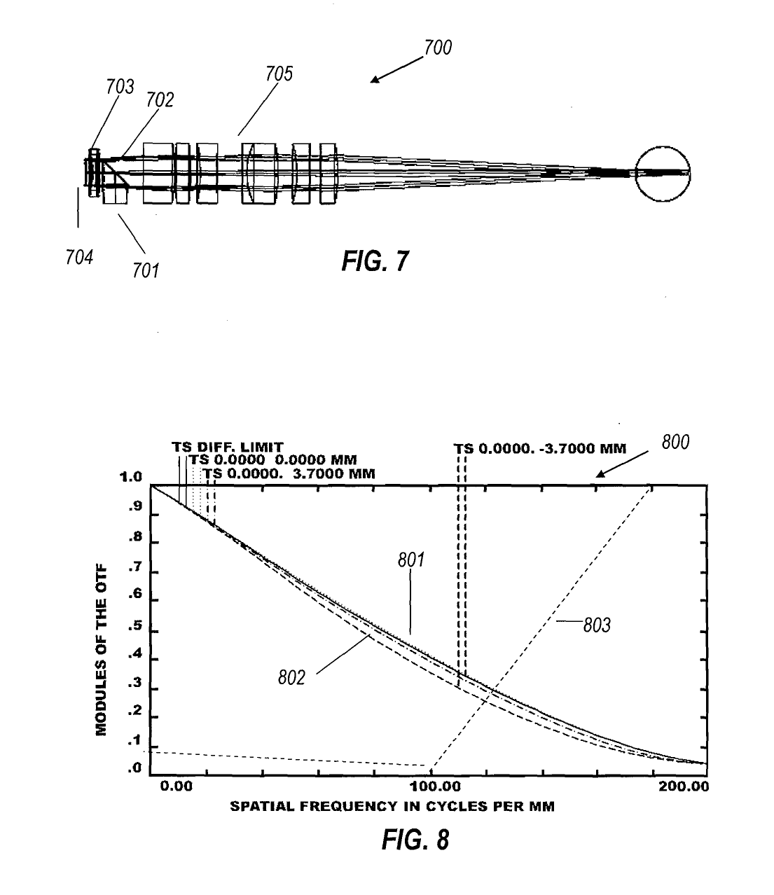

The image source of projector 700 shown in FIG. 7, (“object” in the example in Table 3) is the same compact transmission liquid crystal display 701 as in the first embodiment. Beamsplitter 702 (Surface 1 in Table 3), directs the display output to the assembly of negative achromatic doublet 703 (bounded by surfaces 2, 3, and 4) and micromachined membrane mirror 704 (surface 5) made by Flexible Optics Corp or equivalent component from another manufacturer. After reflection at the membrane mirror, a 2D image “slice” passes back through achromatic doublet 703 (surfaces 6, 7, and 8) and beamsplitter 702 (inactive surface 9) and is projected to the eye by reverse telephoto lens 705 (surfaces 10 through 23). Optically inactive surface 16 is an aperture stop of the reverse telephoto lens, and is separately enumerated for convenience. The position of the exit pupil of the projection lens is conjugated with the eye pupil of the observer. The diameter of the exit pupil of the projection lens exceeds the eye pupil diameter so the observer has some flexibility in head position, and the distance between the two projectors does not need to be adjusted too critically for each observer.

Membrane mirror 704 (surface 5) which has a 10 mm clear aperture, changes its radius of curvature from infinity to 150 mm. The curved membrane mirror, in combination with the reverse telephoto lens, creates a virtual image of the display output, at a distance from the exit pupil that is controllable by varying the curvature of the membrane mirror. The optical system was designed in four configurations listed in Table 4 below.

TABLE 4

| Surface | Parameter. | Config. 1 | Config. 2 | Config. 3 | Config. 4 |
|---|---|---|---|---|---|
| 5 | Curvature | 6.666E−3 | 6.666E−3 | 6.666E−3 | 0 |
| 24 | Y-axis | 2.5 | 0 | −2.5 | 0 |
| | decentering | | | | |
| 25 | focal length | 17 | 17 | 17 | 16.75 |

In configurations 1, 2, and 3 the radius of curvature of the mirror is 150 mm, or the curvature is 0.006666 in Table 1. When membrane mirror has 150 mm radius of curvature, the image is projected from infinity and a typical human eye, focused on an object at infinity, has a focal length of 17 mm. Using this system the eye can observe images with a field of view of 6 degrees field, which can be increased in a further development. The system was optimized for three eye positions: centered (Configuration 2), and shifted ±2.5 mm (Configurations 1 and 3) and for waveband 0.45-0.65 microns.

In the second embodiment the MMDM operates with a 10 mm clear aperture. A mirror with 10 mm clear aperture and with 150 mm radius of curvature has an 80 microns sag.

Current commercially available Flexible Optics Membrane Micromachined Deformable mirrors designed for real time adaptive optics wavefront correction have a maximum correction span of 25 microns. Nevertheless the 80 microns or more sag can be achieved with currently available technology. (Private communication with Dr. G. Vdovin of Flexible Optics Corp.)

The projector shown in FIG. 7 has a 6° field of projection, giving 5 mm diameter between the extreme positions of the center of a pupil wholly within the field, and a 7 mm diameter eyebox defined as requiring half the pupil field inside the eyebox, assuming a pupil diameter of 2 mm, at a 100 mm spacing between the last element (surface 23) of the projector and the front of the eye.

The image quality (MTF) for configuration 2, with the observer's eye in the center of the eye box and focused at infinity, is shown in FIG. 8. As may be seen from FIG. 8, the system image quality is practically diffraction limited (FIG. 8) and with a 2 mm eye pupil diameter has retinal resolution of 130 pair lines/mm.

In FIG. 8, MTF diagram 800 shown in the same coordinate system as MTF in FIG. 3. Topmost, solid, MTF curve 801 describes a theoretically perfect lens, known as diffraction limited, of the same diameter as those of FIG. 7. Dotted, dashed, and chain-dotted lines 802 show the projector performance with the eye located at the center of eyebox. Lines 802 show the performance at the center and edge of the instantaneously viewed field, with separate sagittal and meridional lines at the edge of the field. Widely dashed line 803 is a schematic sketch of the fovea's modulation threshold of visibility, above which all grating modulations are visible. The point at which line 803 crosses MTF curves 802 indicates the actual system performance at the retina.

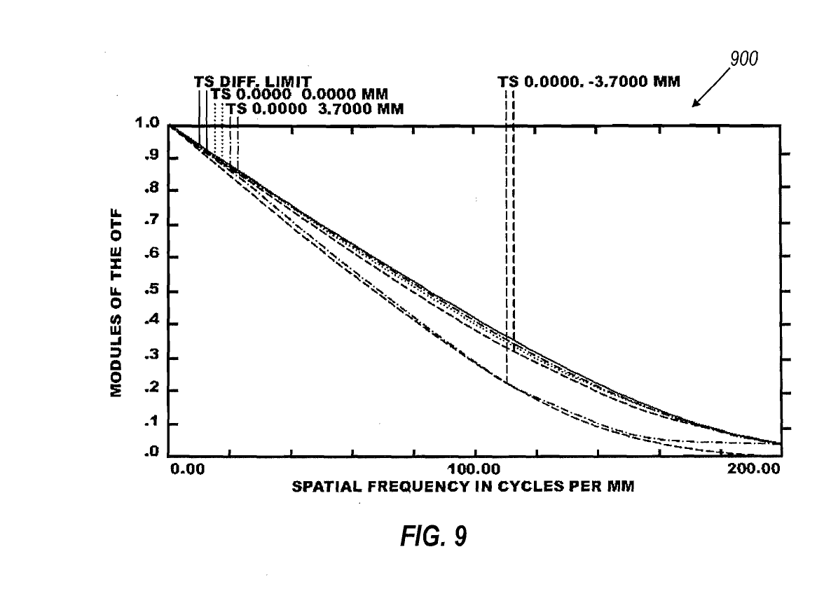

FIG. 9 shows an MTF diagram 900 of the system of the second embodiment with an observer's eye at the edge of eyebox and the virtual object at infinity. The system image quality is practically diffraction limited. The image quality of Configuration 4 when the virtual object is located at the distance of 1.1 meter from observer is diffraction limited and not shown in drawings.

The mirror response time is about 1 millisecond. Currently available LC displays can operate with 150 Hz frequencies. So the system is able to generate up to 5 depth image “slices” during each 33-millisecond frame. At every frame the observer will receive five pairs of stereoshifted image “slices” located at five different distances from observer. The observer can focus his or her eyes on the chosen depth in accordance with the distance perception given by the stereo disparity of each depth slice.

While in the first and second preferred embodiments shown above the MMDM was used as an optical element of variable power, other technologies can be also be used. One example of a competitive technology to MMDM is to use a stack (sandwich) of electro-switchable LC Fresnel lenses. Another feasible competitive technology can be the stack of electro-switchable LC Fresnel zone plate lenses. A suitable lens system is described in Y. Fan, H. Ren, S. Wu “Switchable Fresnel lens using polymer-stabilized LC”, Opt. Express, Vol. 11, No. 23, 2003, which is incorporated herein by reference in its entirety. In both of these technologies the electro-optical lenses can be switched on and off during the imaging frame to create an array of precalculated focal powers. At any moment only one lens will be activated. In this case the number of projected depth slices will be equal to the number of LC Fresnel lenses packaged in the stack. A more sophisticated algorithm includes the use of LC Fresnel lenses switchable in combination, allowing in principle up to 2ⁿ−1 depth slices for n lenses.

Referring to FIG. 10, a preferred embodiment 1000 of the binocular projection system is disclosed herein comprising two projectors, each of which may be as shown in FIGS. 1 and 2 or in FIG. 7, serving observer 1001. Each projector dynamically creates a succession of depth-slices of a 3D scene, wherein each stereo pair of depth slices has a disparity and apparent image distance that are in accordance with the supposed distance from the objects depicted in that slice to the observer.

The displays 101, 701 and the mirrors 105, 705 or other optical elements of variable power are controlled by a driver, shown functionally in FIG. 11. The driver typically comprises a processor, non-volatile memory or other storage media for programs, volatile working memory, and storage and/or input for video data. The driver is arranged in use to cause the display to generate successive outputs representing slices of a scene at different distances from an observer position, and to cause the optical element of variable power to change power in synchrony with the display, so as to produce an image of each output at an appropriate apparent distance from the observer position.

The projection system shown in FIG. 10 has a source of pairs of outputs for the two projectors, in the form of data memory with the image data for the pairs of outputs. The image data may be in the form of pairs of slice images, 3D object data from which a fast driver can calculate the slice data in real time, or any suitable intermediate form. For storage, the slice-image data may be compressed, either in time or in space or both. A non-transitory recording and/or storage medium containing sets of pairs of slice images for the different depth slices, with the correct parts of each slice blacked out for consistent apparent occlusion of objects in slices more distant from the observer by objects in slices nearer the observer, may be provided. Image data in the form of slice images may be accompanied by metadata specifying the correct apparent distance from the observer for each slice. In the case of a motion picture or other time-varying series of images, such metadata may be defined for the whole series, for part of the series, or for individual images.

FIG. 11 shows a flowchart for a preferred embodiment binocular projection system utilizing standard Left-Right video input. For LED backlights, those will comprise the 3 RGB input video channels for the left and right, which are to be subtracted. Well-known horizontal cross-correlation algorithms can rapidly interrogate the five cardinal depths in order to establish a disparity map. From that and the color segmentation, the edges of the various objects can be detected. Complete object segmentation will re-establish the original left and right videos, but parsed within five depth slices. FIG. 11 shows how the adaptive depth slicing can utilize a different depth-parsing in each frame, as indicated by the 5 evenly spaced solid arrows and the differently positioned dashed arrows. Where the slices are generated in real time, the slice depths may be determined by analysis of the image at the same time. Where slices are generated in advance, deliberate slice depth selection by a human operative may be feasible and appropriate. Of course in actual video there is total inter-frame change only at scene-switches, and most adjacent video frames are very little changed overall. Thus, even if the slice depths are variable within a video, they may be changed only when the scene changes, and not every frame, saving both computing power and data volume. As further shown in the flowchart of FIG. 11, the sequencer sends the successive LCD depth-slice images and their attendant diopter values for the flexible mirror to adopt during each fifth of the video frame duration.

For example, the pair of slice images for a single slice will typically be identical except for small zones, particularly at the edges of occluding objects in slices nearer the observer, as well as side surfaces of objects in each slice, and for the offsetting of objects at different depths within each slice. For example, the images for successive frames of an animated or otherwise moving image will similarly often have only small differences. Techniques for the efficient compression of images that are only slightly different are well known and, in the interests of conciseness, are not described here.

The binocular projector system disclosed herein can provide the observer with a natural perception of 3D scenes. It can be used in new generation of 3D TV systems, 3D displays, 3D head mounted displays, video games stations, flight simulators, Unmanned Aerial Vehicles control console simulators, Unmanned Ground Vehicle control console simulators, and other such 3D video systems.

Although specific embodiments have been described, the person skilled in the art will understand how variations may be made, and how features of different embodiments may be combined. For example, the number of slices proposed was based on the persistence of vision of the human eye, for which a frame refresh time of 33 milliseconds, corresponding to the 30 frames per second that is standard for television and video in the U.S.A., is reasonable for avoiding perceptible flicker, given the response speed of the available LC displays. If a faster display is available, the number of frames per second may be increased to reduce flicker. Alternatively, or in addition, the number of depth slices may be increased, though only at the expense of flux throughput, requiring brighter illumination. Conversely, the frame rate may be reduced, to reduce the demand on system resources, or free up resources to increase the number of slices, if a more noticeable flicker is acceptable.

In a desirable embodiment, at the display's working distance the diameter of the exit pupil of each projector is 60 mm, and the centers of the exit pupils are 60 mm apart, corresponding to the separation of the eyes of a typical human observer. Thus, the exit pupils of the two projectors constitute two touching circles. An observer needs only to place the pupil of left eye anywhere in the exit pupil of the left projector and the right eye anywhere in the exit pupil of the right projector. The proposed 3D display thus does not need adjustment to eye pupil diameter and eye spacing of different observers, and can permit sufficient movement of the observer's eyes and head to permit of comfortable viewing.

In an embodiment of a process for using the projection systems described, the generation of the still 3D scene begins with a standard geometrical procedure of calculating the obscuration of objects by other objects from the observer's viewpoint, and revealing the array of the active visible points at the scene. Then the array of the angular stereo disparities for the active points will be calculated. Because of the stereo disparity, the active visible points in partly obscured slices are different for the two eyes. The calculations can be made for the standard 60 mm observer eye separation, or adjusted for the eye spacing of a specific customer or other observer or category of observers.

In an embodiment, to generate the 3D scene the whole depth space from 250 mm distance to infinity will be divided into 5 zones at equal increments of eye accommodation power, which is proximately 1 diopter of accommodation for each zone. All objects and associated stereoshift data in the scene will be combined into 5 depth-slice files in accordance with the zone in which each object is located. Arrays of the angular stereoshifts will be transformed into arrays of linear lateral shifts in the focal plane of the projectors, and five slices will be generated in a cycle of 33 milliseconds. Each depth slice will be generated with the deformable mirror set to the radius of curvature associated with the position of that slice. For a dynamic scene, the still scene simulation algorithm will be repeated per 33 millisecond cycle with a new position of any moving object in each cycle.

In the above description, it has been assumed that the slice images are generated in pairs, one for each eye at a common depth, and that the pairs are generated in sets of five, one pair for each of the five depth slices, from or for a single 3D image, or a single 3D frame of a video sequence. It has also been assumed that the images are projected in their pairs, with the two projectors operating in synchrony. Those constraints are not strictly necessary, but as a practical matter it is usually most efficient to render a single 3D frame into five pairs of slices, because much of the analysis can be more efficiently used. For example, a single calculation of occlusion of objects in more distant layers by objects in nearer layers can then be used in generating all of the layers involved.

The preceding description of the presently contemplated best mode of practicing the invention is not to be taken in a limiting sense, but is made merely for the purpose of describing the general principles of the invention. The full scope of the invention should be determined with reference to the Claims.

We claim:

1. A binocular 3D projection system comprising dual projectors each dynamically creating a succession of depth-slices fully comprising a 3D scene, wherein each pair of said depth slices has a stereoshift and is displayed in the form of a pair of images at a selected apparent distance from the observer, the parameters of said stereo-disparity and apparent distance being that of the object-distance to be binocularly displayed to the observer.

2. The projection system of claim 1 in which each projector comprises a liquid crystal (LC) display, a deformable membrane mirror, projection optics, and depth-slicing driver electronics.

3. The projection system of claim 2 wherein the optics of each said projector comprise a reverse telephoto lens, said telephoto lens having sufficient back focus release for mounting said LC display and said membrane mirror.

4. The projector of claim 3 with a long distance exit pupil release for conjugation with said observer's eye pupil.

5. The projector of claim 2 wherein the exit pupil diameter is sufficiently large to form an eye box at least 7 mm in diameter.

6. The projector of claim 2 also comprising an achromatic negative doublet in the path of light to and from said deformable mirror.

7. A binocular 3D projection system comprising:
dual image projectors, each said projector comprising an image display, an optical element of variable power, and an electronics driver, said driver successively generating image-segments of a 3-D input scene, each said image-segment representing a depth-slice of said 3-D input scene, parsed into their different distances from said observer, and said driver in operation causing the optical element of variable power to alter its overall power such that each said depth-slice is displayed in the form of an image having an appropriate apparent distance from an observer.

8. The projection system of claim 7, further comprising a source of stereo pairs of 3-D image outputs for said two projectors, said source producing a stereo disparity consistent with the apparent distance from the observer position of each said pair.

9. The projection system of claim 7, wherein the optical element of variable power is a deformable membrane mirror.

10. The projection system of claim 7, wherein the optical element of variable power is a plurality of electrically switchable liquid crystal Fresnel lenses.

11. The projection system of claim 7, wherein the optical element of variable power is a plurality of electrically switchable liquid crystal Fresnel zone plate lenses.

12. The projection system of claim 7, further comprising optical elements that cooperate with said optical element of variable power to produce the appropriate apparent distance from the observer position for each said depth-slice.

13. The projection system of claim 12, wherein the optics comprise a reverse telephoto lens in the light path from the optical element of variable power to the observer position.

14. The projection system of claim 12, wherein the optical element of variable power is a deformable concave mirror and said optical elements further comprise an achromatic negative doublet adjacent to said deformable mirror.

15. The projection system of claim 7, wherein the exit pupil diameter of each projector is larger than the diameter of the pupil of an observer's eye.

16. A 3D projection system comprising:
a display;
an optical system including an element of variable optical power arranged to form an image of the display visible from a viewpoint at an apparent distance from the viewpoint dependent on the power of the element of variable optical power; and
a driver operative to control the display and the element of variable optical power so as to produce a plurality of said visible images at different apparent distances from the viewpoint at a rate sufficiently fast to be perceived by normal human vision as a single image having depth.

17. The 3D projection system of claim 16, further comprising a second display and a second optical system, the first and second optical systems positioned to form respective images of the first and second displays visible to the two eyes of a human observer at the viewpoint, and wherein the driver is operative to supply to the displays pairs of images having stereoshifts, and to synchronize the displays and the powers of the elements of variable optical power such that each pair of images is visible at an apparent distance from the viewpoint consistent with its stereoshift.

18. The 3D projection system of claim 17, further comprising a source of sets of pairs of said images having stereoshifts, each set comprising pairs of images that when displayed at said apparent distances from the viewpoint consistent with their stereoshifts combine to form a self-consistent 3D image.
